(19) United States
(12) Patent Application Publication
(10) Pub. No.: US 2024/0312749 A1
(43) Pub. Date: Sep. 19, 2024

(54) Short-Circuit-Resistant Relay

(71) Applicant: SANYOU CORPORATION LIMITED, Dongguan (CN)

(72) Inventors: Yabin Wang, Dongguan (CN); Rongai Yu, Dongguan (CN); Junping Tang, Dongguan (CN); Luning Zhu, Dongguan (CN); Zhenwei Liu, Dongguan (CN)

(21) Appl. No.: 18/676,564

(22) Filed: May 29, 2024

Related U.S. Application Data
(63) Continuation of application No. PCT/CN2021/143467, filed on Dec. 31, 2021.

(30) Foreign Application Priority Data
Dec. 13, 2021 (CN) 202111518789.6

(51) Int. Cl. H01H 50/58

(52) U.S. Cl. CPC H01H 50/58

(57) ABSTRACT

A short-circuit-resistant relay includes a fixed base, a contact lead-out end, a push rod assembly, a first and a second magnetically guiding sheet. Provided are at least two contact lead-out ends providing with stationary contact, both ends of the movable spring sheet are provided with movable contacts, the first magnetically guiding sheet is movably provided, along a direction in parallel to the movement of the movable spring sheet, on a side of the movable spring sheet facing the stationary contact, and the second magnetically guiding sheet is provided on a side of the movable spring sheet distal to the stationary contact, in which the first and second magnetically guiding sheets are capable of forming a magnetic loop, and the first magnetically guiding sheet moves in a direction facing the second magnetically guiding sheet and in parallel to the movement of the movable spring sheet within a preset travel.

### CROSS REFERENCE TO RELATED APPLICATIONS

The present application is a Continuation Application of PCT Application No. PCT/CN2021/143467 filed on Dec. 31, 2021, which claims the benefit of Chinese Patent Application No. 202111518789.6 filed on Dec. 13, 2021. All the above are hereby incorporated by reference in their entirety.

### FIELD

The present disclosure relates to the technical field of relays and, particularly, to a short-circuit-resistant relay.

### BACKGROUND

Such relays of the prior art generate electric repulsion between the movable contact and stationary contact when a fault of short-circuit current occurs, which affects the stability of the contact between the movable contact and the stationary contact.

With the rapid development of the new energy industry, the requirements for fault of short-circuit current in vehicle manufacturers and battery pack manufacturers are getting increasingly high. On the basis of maintaining the characteristics of compact size and low coil power, the relay is required to have the function of short-circuit resistance, which may resist the electric repulsion of the movable spring when the system suffers a fault of high current.

At present, the typical market requirements of the short-circuit resistance are required to ensure that the circuit will not burn or explode at 8000A in 5 ms. However, the DC relay of the prior art is not able to provide sufficient contact pressure while keeping the characteristics of compact size and low coil power, i.e., the contact pressure is insufficient to resist the electric repulsion subjected to the movable spring.

In order to improve the ability to resist electric repulsion, in the prior art, Chinese Patent Application No. 201811125654.1 discloses a DC contactor with high short-circuit resistance, including a housing, whose internal chamber is mounted with two stationary contacts, a movable contact sheet, and a driving mechanism. The movable contact sheet and the two stationary contacts are arranged opposite to each other in a vertical direction, and the drive mechanism is provided with a coil, a rotor and a push rod. It is also provided with a support member made of ferromagnetic material to support the movable contact sheet and a blocking member made of ferromagnetic material, the support member together with the movable contact sheet is movably sheathed to an upper part of the push rod, and the blocking member is positioned to be sheathed to an upper part of the push rod and is also positioned on the upper part of the support member and the movable contact sheet. When the movable contact sheet is attracted and connected to the two stationary contacts respectively, the blocking member is able to form a magnetic loop clearance with a top side of the support member to generate an electromagnetic attraction force to the movable contact sheet in an upward direction. In such a case, under high current, it ensures that the movable contact sheet and the two stationary contacts are kept attracted, which greatly improves the DC contactor's working stability and short-circuit resistance.

However, since the push rod is required to overtravel, it is inevitable that a clearance is generated between the support member and the blocking member, and generally the size of the clearance is equal to the distance of overtravel of the push rod. Due to the relatively large clearance between the support member and the blocking member, the ability of the relay to resist electric repulsion is significantly reduced. Therefore, it is not possible to meet the actual use requirements for passing high currents under short-circuit conditions.

Therefore, an improvement proposal is required.

### SUMMARY

To overcome at least one of the aforementioned deficiencies of the prior art, provided in the present invention is a short-circuit-resistant relay to optimize the existing structural deficiencies of the relay in order to improve the short-circuit-resistant performance of the relay.

The technical solutions adopted by the present disclosure to solve the problems are as follows.

In accordance with an aspect of the present disclosure, provided in the present disclosure is a short-circuit-resistant relay, including: a fixed base; a contact lead-out end, fixed to the fixed base, provided with a stationary contact, provided being at least two contact lead-out ends; push rod assembly; movable spring sheet, provided with movable contacts corresponding to the stationary contact, movably provided with respect to the push rod assembly in a direction in parallel to the movement of the push rod assembly; a first magnetically guiding sheet, movably provided on a side of the movable spring sheet facing the stationary contact; and a second magnetically guiding sheet, provided on a side of the movable spring sheet distal to the stationary contact, capable of forming a magnetic loop with the first magnetically guiding sheet, wherein the first magnetically guiding sheet moves in a direction facing the second magnetically guiding sheet and in parallel to the movement of the movable spring sheet within a preset travel, when the push rod assembly drives the movable spring sheet to actuate the movable contact of the movable spring sheet to contact the stationary contact of the contact lead-out end and the push rod assembly continues to actuate to achieve overtravel.

Further, the relay also includes an overtravel elastic member, applying to the movable spring sheet with an overtravel elastic force facing the stationary contact when the push rod assembly actuates to achieve an overtravel.

Further, the relay further includes a restricting structure connected to the first magnetically guiding sheet; and the restricting structure restricts a position of the first magnetically guiding sheet when the first magnetically guiding sheet approaches the second magnetically guiding sheet in a preset travel, so that a distance between the first magnetically guiding sheet and the second magnetically guiding sheet is in a preset range.

Further, the push rod assembly includes a push rod and an electromagnetic assembly driving the push rod to move, the movable spring sheet is provided with a first through-hole, the push rod slidably passes through the first through-hole, and the first magnetically guiding sheet slidably connected to the push rod.

Further, the restricting structure is provided on the push rod and positioned between the first magnetically guiding sheet and the movable spring sheet.

Further, the restricting structure is a stopper fixedly connected to the push rod.

Further, the push rod includes a first sliding segment and a second sliding segment, an outer diameter of the first sliding segment is less than an outer diameter of the second sliding segment, the restricting structure is a step segment formed at a connecting position between the first sliding segment and the second sliding segment, the sliding segment is slidably cooperated with the first through-hole, the first magnetically guiding sheet is provided with a second through-hole, and the first sliding segment is slidably cooperated with the second through-hole.

Further, the first magnetically guiding sheet is provided with a fit groove cooperated with the step segment around the second through-hole, and the fit groove is positioned on a side of the first magnetically guiding sheet facing the movable spring sheet.

Further, an end of the push rod proximal to the movable spring sheet is provided with a blocking member; the relay further includes a first sliding column, an end of the first sliding column is fixed to the first magnetically guiding sheet, the first sliding column slides through the blocking member, and the restricting structure is positioned on an end of the first sliding column distal to the first magnetically guiding sheet and is capable of being abutted against a surface of the blocking member distal to the first magnetically guiding sheet; or an end of the first sliding column is fixed to the blocking member, the first sliding column passes through the first magnetically guiding sheet, and the restricting structure is positioned on an end of the first sliding column distal to the first magnetically guiding sheet and is capable of being abutted against a surface of the first magnetically guiding sheet distal to the blocking member; or the restricting structure includes a first restricting end and a second restricting end, the first restricting end and the second restricting end are provided on both ends of the first sliding column respectively, the first sliding column slides through the first magnetically guiding sheet and the blocking member, the first restricting end is capable of being abutted against a surface of the blocking member distal to the first magnetically guiding sheet, and the second restricting end is capable of being abutted against a surface of the blocking member distal to the first magnetically guiding sheet.

Further, the fixed base is provided with a guiding protrusion on both sides of the first magnetically guiding sheet and the second magnetically guiding sheet, and two guiding protrusions are kept to be spaced apart to form a first guiding slot for the first magnetically guiding sheet and the second magnetically guiding sheet to slide.

Further, the push rod assembly includes a push rod and an electromagnetic assembly driving the push rod to move, an end of the push rod is provided with push plate, and the push plate is connected to the movable spring sheet via the overtravel elastic member.

Further, two guiding plates provided on opposite sides of the movable spring sheet, two guiding plates form a second guiding slot for the movable spring sheet to slide, and an end of the guiding plate distal to the push plate is provided with a restricting plate.

Further, the guiding plate is provided on the fixed base.

Further, the guiding plate is fixed to the push rod and/or the push plate, and the first magnetically guiding sheet is slidably connected to the restricting plate and/or the guiding plate.

Further, the relay also includes a second sliding column; an end of the second sliding column is fixed to the first magnetically guiding sheet, the second sliding column slides through the restricting plate, the restricting structure is positioned on an end of the second sliding column distal to the first magnetically guiding sheet; or an end of the second sliding column is fixed to the restricting plate, the second sliding column passes through the first magnetically guiding sheet, and the restricting structure is positioned on an end of the second sliding column distal to the first magnetically guiding sheet and is capable of being abutted against a surface of the first magnetically guiding sheet distal to the restricting plate; or the restricting structure comprises a third restricting end and a fourth restricting end, the third restricting end and the fourth restricting end are provided on both ends of the second sliding column respectively, the second sliding column slides through the first magnetically guiding sheet and the restricting plate, the third restricting end is capable of being abutted against a surface of the restricting plate distal to the first magnetically guiding sheet, and the fourth restricting end is capable of being abutted against a surface of the restricting plate distal to the first magnetically guiding sheet.

Further, the restricting structure includes a restricting slot provided on the first magnetically guiding sheet, and the restricting plate is slidably connected to the restricting slot.

In view of the technical solutions mentioned above, the embodiments of the present disclosure provide at least the following advantages and positive effects.

The first magnetically guiding sheet moves within a preset travel in a direction facing the second magnetically guiding sheet, when the push rod assembly drives the movable spring sheet 3 to move in a direction facing the stationary contact to allow the movable contact to contact the stationary contact and the push rod assembly continues to actuate to achieve overtravel. It shortens the distance between the first magnetically guiding sheet and the second magnetically guiding sheet, so that the current flows in from a contact lead-out end through the movable spring sheet and flows out from the other contact lead-out end. Since the first magnetically guiding sheet and the second magnetically guiding sheet form a magnetic loop, the current flowing through the movable spring sheet magnetizes the first magnetically guiding sheet and the second magnetically guiding sheet, so that the first magnetically guiding sheet and the second magnetically guiding sheet are attracted with each other, thereby applying to the movable spring sheet with a pressing force directing to the stationary contact via the second magnetically guiding sheet. Since the first magnetically guiding sheet and the second magnetically guiding sheet are close to each other, the magnetic attraction force between them may be increased, thereby allowing the closure between the movable contact and the stationary contact to be more stable and reliable, so as to resist the electric repulsion generated by a relatively high current when short-circuiting.

### BRIEF DESCRIPTION OF THE DRAWINGS

FIG. 1 is a schematic internal diagram of a side view of the relay in embodiment 1 of the present disclosure;

FIG. 2 is a schematic internal diagram of a front view of the relay in embodiment 1 of the present disclosure;

FIG. 3 is an enlarged view of FIG. 2 at A;

FIG. 4 is a schematic diagram of the connection relationship and positional relationship of the contact lead-out end, the movable spring sheet, the first magnetically guiding sheet, and the second magnetically guiding sheet of the relay in the contact disconnected state in embodiment 1 of the present disclosure;

FIG. 5 is a schematic internal diagram of a perspective view of the relay in embodiment 1 of the present disclosure;

FIG. 6 is a schematic state diagram of the relay in embodiment 1 of the present disclosure when the movable contact is closed to the stationary contact;

FIG. 7 is a schematic state diagram of the relay in embodiment 1 of the present disclosure when the armature is closed to the fixed iron core;

FIG. 8 is a schematic diagram of the first connection relationship of the restricting structure and the first magnetically guiding sheet in embodiment 2 of the present disclosure;

FIG. 9 is a schematic diagram of the second connection relationship of the restricting structure and the first magnetically guiding sheet in embodiment 2 of the present disclosure;

FIG. 10 is a schematic diagram of the third connection relationship of the restricting structure and the first magnetically guiding sheet in embodiment 2 of the present disclosure;

FIG. 11 is a schematic diagram of the connection relationship and positional relationship of the contact lead-out end, the movable spring sheet, the first magnetically guiding sheet, and the second magnetically guiding sheet of the relay in the contact disconnected state in embodiment 3 of the present disclosure;

FIG. 12 is a schematic diagram of the relay in the contact disconnected state in embodiment 3 of the present disclosure;

FIG. 13 is a schematic state diagram of the relay in embodiment 3 of the present disclosure when the movable contact is closed to the stationary contact;

FIG. 14 is a schematic state diagram of the relay in embodiment 3 of the present disclosure when the armature is closed to the fixed iron core;

FIG. 15 is a schematic diagram of the first connection relationship of the restricting structure and the first magnetically guiding sheet in embodiment 3 of the present disclosure;

FIG. 16 is a schematic diagram of the second connection relationship of the restricting structure and the first magnetically guiding sheet in embodiment 3 of the present disclosure;

FIG. 17 is a schematic diagram of the third connection relationship of the restricting structure and the first magnetically guiding sheet in embodiment 3 of the present disclosure;

FIG. 18 is a schematic diagram of the first connection relationship of the first magnetically guiding sheet and the restricting plate in embodiment 4 of the present disclosure;

FIG. 19 is a schematic diagram of the second connection relationship of the first magnetically guiding sheet and the restricting plate in embodiment 4 of the present disclosure.

The meanings of the attached markings are as follows:

1 fixed base; 101 bottom holder; 102 upper cover; 103 mounting chamber; 2 contact lead-out end; 3 movable spring sheet; 301 first through-hole; 4 push rod assembly; 401 push rod; 4011 first sliding segment; 4012 second sliding segment; 4013 step segment; 4014 push plate; 402 electromagnetic assembly; 4021 support; 4022 coil; 4023 fixed iron core; 4024 magnetically guiding panel; 4025 yoke; 4026 armature; 5 overtravel elastic member; 6 first magnetically guiding sheet; 601 second through-hole; 602 fit groove; 603 restricting slot; 7 restricting structure; 8 second magnetically guiding sheet; 9 arc extinction structure; 10 reset elastic member; 11 blocking member; 12 guiding protrusion; 1201 first guiding slot; 13 first sliding column; 1301 first restricting end; 1302 second restricting end; 14 guiding plate; 1401 second guiding slot; 15 restricting plate; 16 second sliding column; 1601 third restricting end; 1602 fourth restricting end.

### DETAILED DESCRIPTION OF THE EMBODIMENTS

For a better understanding and implementation, the technical solutions in the embodiments of the present disclosure are clearly and completely described below in conjunction with the attached drawings of the present disclosure.

In the description of the present disclosure, it is to be noted that the terms “up”, “down”, “front”, “back”, “left”, “right”, “vertical”, “horizontal”, “top”, “bottom”, “inside”, “outside” and other orientation or position relationships are based on the orientation or position relationships shown in the attached drawings. It is only intended to facilitate description of the present disclosure and simplify description, but not to indicate or imply that the referred device or element has a specific orientation, or is constructed and operated in a specific orientation. Therefore, they should not be construed as a limitation of the present disclosure.

Unless otherwise defined, all terms including technical and scientific terms used herein have the same meaning as commonly understood by those skilled in the art to which the present disclosure belongs. The terms used herein in the specification of the present disclosure are used only to describe specific embodiments and are not intended as a limitation of the disclosure.

### Embodiment 1

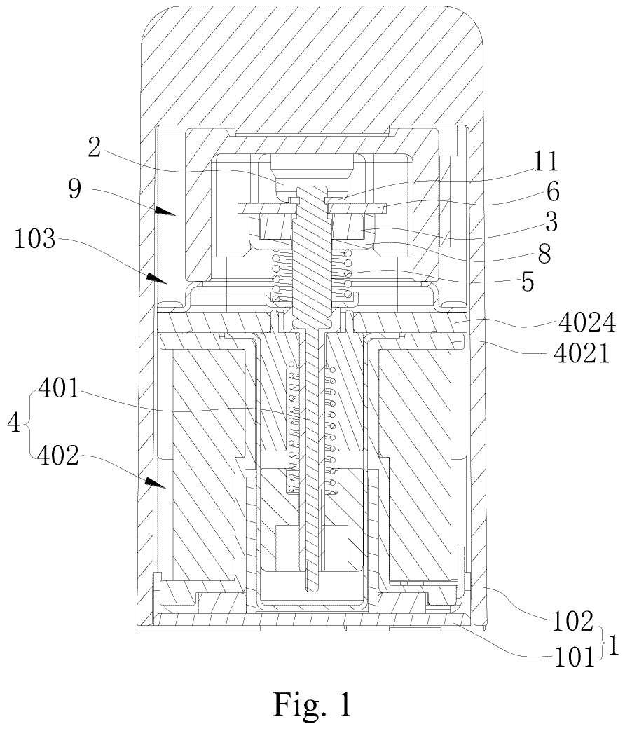

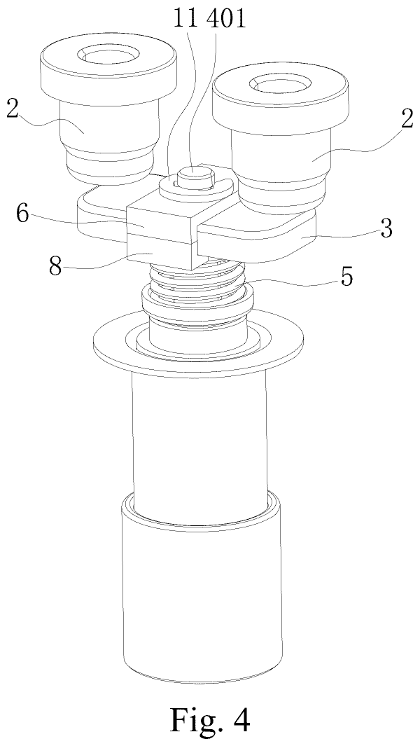

Referring to FIGS. 1-7, disclosed in the present disclosure is a short-circuit-resistant relay, including a fixed base 1, a contact lead-out end 2, a movable spring sheet 3, a push rod assembly 4, an overtravel elastic member 5, a first magnetically guiding sheet 6, and a second magnetically guiding sheet 8, wherein the fixed base 1 includes a bottom holder 101 and an upper cover 102, a mounting chamber 103 is provided within the bottom holder 101 and the upper cover 102, an arc extinction structure 9 is also provided within the mounting chamber 103, and the arc extinction structure 9 may be referred to other prior art, which is not repeated herein.

The contact lead-out end 2 is fixed to the fixed base 1. As shown in figures, the contact lead-out end 2 is fixed to the upper cover 102, provided are at least two contact lead-out ends 2 with stationary contacts (not shown in figures), the stationary contacts are spaced apart and provided insulatively.

Both ends of the movable spring sheet 3 are provided with movable contacts (not shown in figures) corresponding to the stationary contact, and each stationary contact corresponds to one movable contact.

The movable spring sheet 3 is movably provided with respect to the push rod assembly 4 and is driven by the push rod assembly 4 to move close to or away from the stationary contact.

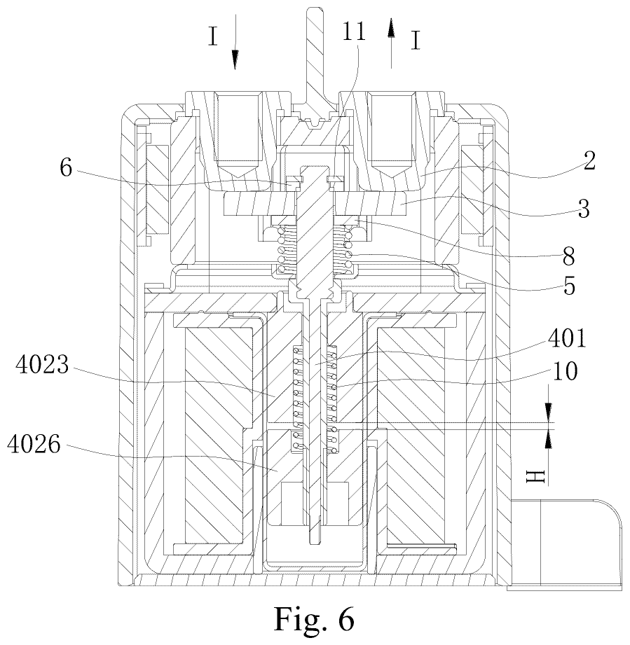

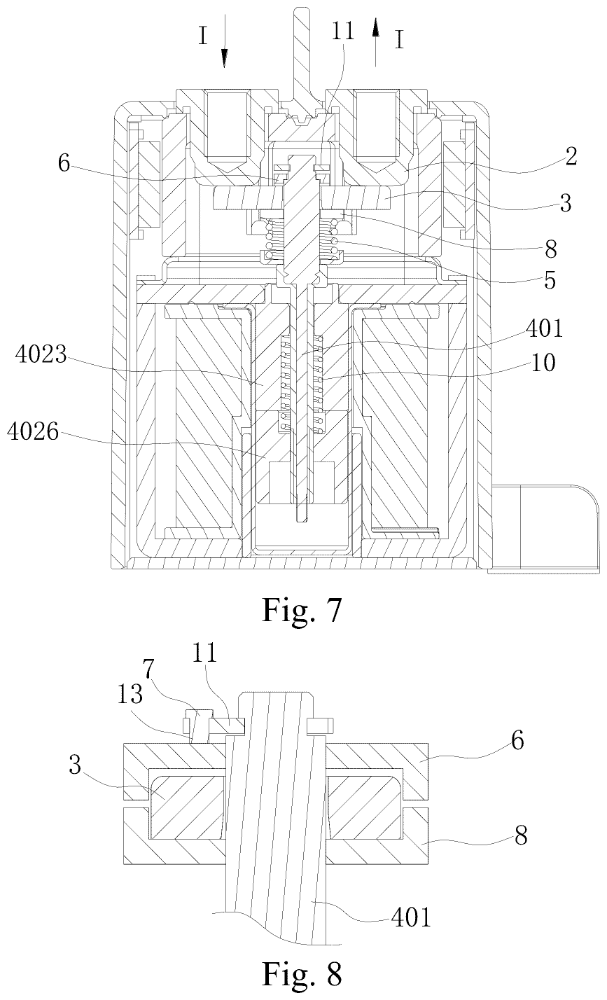

The push rod assembly 4 is used to drive the movable spring sheet 3 to actuate, so that the movable contacts of both ends of the movable spring sheet 3 are in contact with the stationary contacts of two contact lead-out ends 2, achieving the current flowing in from one contact lead-out end 2 through the movable spring sheet 3 and flowing out from the other contact lead-out end 2, which is as shown by I in FIG. 6 or FIG. 7.

The movable spring sheet 3 is movably provided, in a direction parallel to a sliding direction of the push rod assembly 4, with respect to the push rod assembly 4.

The overtravel elastic member 5 applies to the movable spring sheet 3 with an overtravel elastic force facing the stationary contact when the push rod assembly 4 achieves an overtravel.

In some possible implementations, the overtravel elastic member 5 is provided on the push rod assembly 4, and the overtravel elastic member 5 is connected to the movable spring sheet 3 and may apply to the movable spring sheet 3 with an overtravel elastic force in a direction facing the stationary contact.

As shown in FIG. 1, the overtravel elastic member 5 adopts an overtravel spring. In other possible implementations, the overtravel elastic member 5 may also be replaced by an elastic sheet or other components with resilience.

In such an arrangement, the push rod assembly 4 drives the movable spring sheet 3 to move close to the stationary contact, so that the movable contacts on the movable spring sheet 3 are in contact with the stationary contacts to achieve contact closure, and the overtravel elastic member 5 applies to the movable spring sheet 3 with an elastic force directing to the stationary contact, so as to provide an additional pressing force for the closure of the contacts.

A first magnetically guiding 6 is movably provided, along a direction in parallel to the movement of the movable spring sheet 3, on a side of the movable spring 3 facing the stationary contact.

The second magnetically guiding sheet 8 is provided on a side of the movable spring sheet 3 distal to the stationary contact, and the second magnetically guiding sheet 8 is provided corresponding to the first magnetically guiding sheet 6. The first magnetically guiding sheet 6 moves in a direction facing the second magnetically guiding sheet 8 and in parallel to the movement of the movable spring sheet 3 within a preset travel, when the push rod assembly 4 drives the movable spring sheet 3 to actuate the movable contact of the movable spring sheet 3 to contact the stationary contact of the contact lead-out end 2 and the push rod assembly 4 continues to actuate to achieve overtravel.

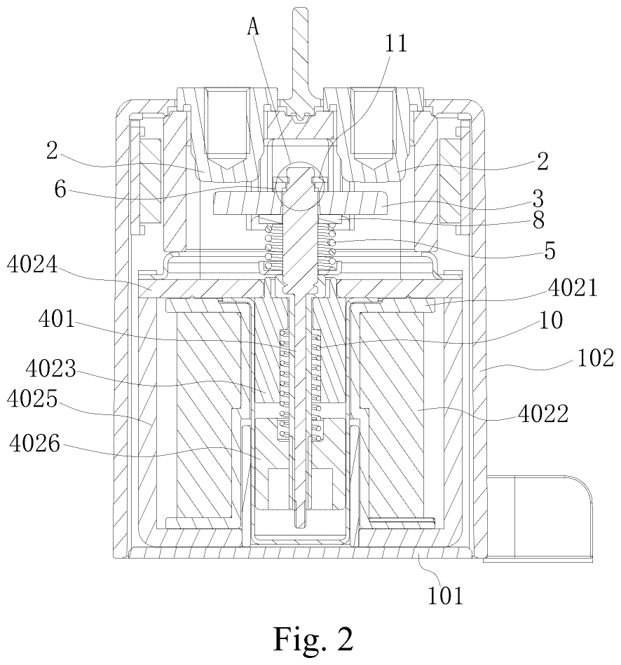

Therefore, referring to FIGS. 2, 6, and 7, during the process of closing the contacts, the push rod assembly 4 drives the movable spring sheet 3 to approach the stationary contact and allows the movable contact to be in contact with the stationary contact. The push rod assembly 4 continues to move forward and, when achieving the overtravel, the first magnetically guiding sheet 6 slides in a direction facing the second magnetically guiding sheet 8, which shortens the distance between the first magnetically guiding sheet 6 and the second magnetically guiding sheet 8, so that the current flows in from a contact lead-out end 2 through the movable spring sheet 3 and flows out from the other contact lead-out end 2. Since the first magnetically guiding sheet 6 and the second magnetically guiding sheet 8 form a magnetic loop, the current flowing through the movable spring sheet 3 magnetizes the first magnetically guiding sheet 6 and the second magnetically guiding sheet 8, so that the first magnetically guiding sheet 6 and the second magnetically guiding sheet 8 are attracted with each other, thereby applying to the movable spring sheet 3 with a pressing force directing to the stationary contact via the second magnetically guiding sheet 8. Since the first magnetically guiding sheet 6 and the second magnetically guiding sheet 8 are close to each other, the magnetic attraction force between them may be increased, thereby allowing the closure between the movable contact and the stationary contact to be more stable and reliable, so as to resist the electric repulsion generated by a relatively high current when short-circuiting.

As shown in FIGS. 1-2, the first magnetically guiding sheet 6 and the second magnetically guiding sheet 8 are provided in one set in a pair.

In other possible implementations, the first magnetically guiding sheet 6 and the second magnetically guiding sheet 8 may be provided with more than two sets.

In some possible implementations, the first magnetically guiding sheet 6 is provided on the push rod assembly 4.

The restricting structure 7 is connected to the first magnetically guiding sheet 6 and the restricting structure 7 restricts a position of the first magnetically guiding sheet 8 when the first magnetically guiding sheet 6 approaches the second magnetically guiding sheet 8 in a preset travel, so that a distance between the first magnetically guiding sheet 6 and the second magnetically guiding sheet 8 is in a preset range.

In some possible implementations, the restricting structure 7 is provided on the push rod assembly 4.

Further, the preset range of the distance between the first magnetically guiding sheet 6 and the second magnetically guiding sheet 8 is a, and the overtravel moving distance of the push rod assembly 4 is H, in which 0≤a<H.

When the distance between the first magnetically guiding sheet 6 and the second magnetically guiding sheet 8 is 0, the first magnetically guiding sheet 6 is abutted against the second magnetically guiding sheet 8.

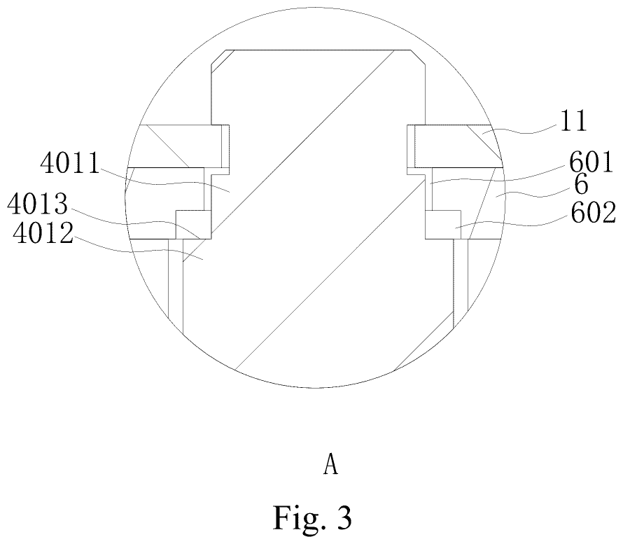

Referring to FIGS. 2-3, in some possible implementations, the push rod assembly 4 includes a push rod 401 and an electromagnetic assembly 402 driving the push rod 401 to move, the movable spring sheet 3 is provided with a first through-hole 301, the push rod 401 slidably passes through the first through-hole 301, and the first magnetically guiding sheet 6 slidably connected to the push rod 401.

In such an arrangement, the push rod 401 may provide a slide guiding for the movable spring sheet 3 and the first magnetically guiding sheet 6.

In some possible implementations, the restricting structure 7 is provided on the push rod 401 and positioned between the first magnetically guiding sheet 6 and the movable spring sheet 3.

Further, the restricting structure 7 is a stopper (not shown in figures) fixedly connected to the push rod 401. For example, the stopper may adopt a snap-ring, and an outer wall of the push rod 401 may be provided with a snap-fit slot for snap-fitting the snap-ring. Alternatively, the stopper may also be a screw or a bolt nut assembly, and the screw or the bolt nut assembly is threaded to the push rod 401. Admittedly, the stopper may also be fixed to the push rod 401 by bonding or welding.

Referring to FIG. 3, in some possible implementations, the push rod 401 includes a first sliding segment 4011 and a second sliding segment 4012, an outer diameter of the first sliding segment 4011 is less than an outer diameter of the second sliding segment 4012, the restricting structure 7 is a step segment 4013 formed at a connecting position between the first sliding segment 4011 and the second sliding segment 4012, the first sliding segment 4011 is slidably cooperated with the first through-hole 301, the first magnetically guiding sheet 6 is provided with a second through-hole 601, and the first sliding segment 4011 is slidably cooperated with the second through-hole 601.

Further, a diameter of the first sliding segment 4011 is greater than that of the second sliding segment 4012 when a cross-section of the push rod 401 is circular.

When the cross-section of the push rod 401 is non-circular, an outer diameter of the first sliding segment 4011 or the second sliding segment 4012 is the maximum dimension of the cross-section thereof. For example, if the cross-section of the push rod 401 is rectangular, the diagonal length of the cross-section of the push rod 401 is then the outer diameter of the first sliding segment 4011 or the second sliding segment 4012.

Therefore, adopting the above structures achieves a sliding connection of the movable spring sheet 3 and the first magnetically guiding sheet 6 to the push rod 401, so that the adjusting part is abutted against the first magnetically guiding sheet 6 to restrict the position thereof. In such an arrangement, the distance between the first magnetically guiding sheet 6 and the second magnetically guiding sheet 8 is controlled in a preset range.

Referring to FIG. 3, in some possible implementations, the first magnetically guiding sheet 6 is provided with a fit groove 602 cooperated with the step segment 4013 around the second through-hole 601, and the fit groove is positioned on a side of the first magnetically guiding sheet 6 facing the movable spring sheet 3.

Therefore, when the first magnetically guiding sheet 6 slides towards the second magnetically guiding sheet 8, the fit groove 602 may be abutted against the step segment 4013, the fit groove 602 may be cooperated with the step segment 4013, and the fit groove 602 is provided to also allow a thickness of the first magnetically guiding sheet 6 to be reduced, which is conducive to achieve the compactness of the structure.

Referring to FIG. 3, further, an end of the push rod 401 proximal to the movable spring sheet 3 is provided with a blocking member 11.

The blocking member 11 is provided to prevent the first magnetically guiding sheet 6 and the movable spring sheet 3 from detaching from an end of the push rod 401.

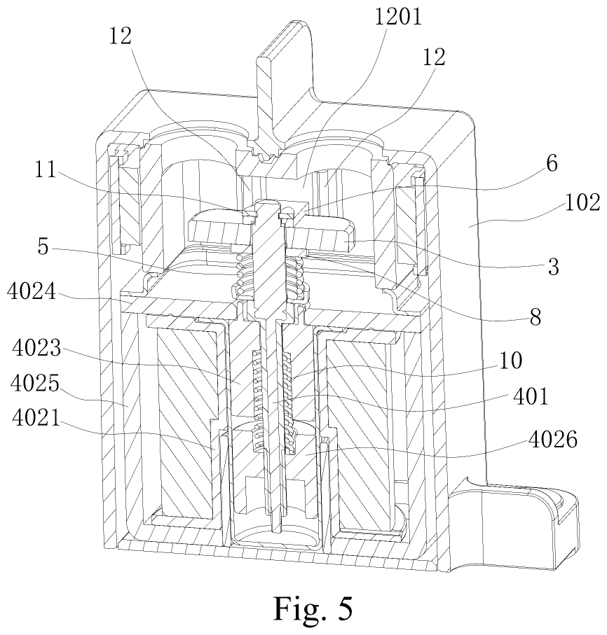

Referring to FIG. 5, further, the fixed base 1 is provided with a guiding protrusion 12 on both sides of the first magnetically guiding sheet 6 and the second magnetically guiding sheet 8, and two guiding protrusions 12 are kept to be spaced apart to form a first guiding slot for the first magnetically guiding sheet 6 and the second magnetically guiding sheet 8 to slide.

In such an arrangement, the first guiding slot provides the movement of the first magnetically guiding sheet 6 and the second magnetically guiding sheet 8 with a guiding direction, which reduces the occurrence of horizontal rotation or overturning of the first magnetically guiding sheet 6 and the second magnetically guiding sheet 8, allowing the magnetic attraction between the first magnetically guiding sheet 6 and the second magnetically guiding sheet 8 to be stable and reliable.

Referring to FIG. 2, further, the electromagnetic assembly 402 includes a support 4021, a coil 4022, a fixed iron core 4023, a magnetically guiding panel 4024, a yoke 4025, and an armature 4026, the coil 4022 is sheathed to an exterior of the fixed iron core 4023, both the fixed iron core 4023 and the yoke 4025 are fixed to the support 4021, the armature 4026 is fixedly connected to the push rod 401, the magnetically guiding panel 4024, the yoke 4025 and the fixed iron core 4023 generate a magnetic flux when the coil 4022 is energized, and the magnetic flux tends to form a closed magnetic loop to drive the armature 4026 to move close to the fixed iron core 4023.

Referring to FIG. 2, further, the relay also includes a reset elastic member 10, the reset elastic member 10 is provided between the fixed iron core 4023 and the armature 4026 to apply to the armature 4026 with a force in a direction away from the fixed iron core 4023, so as to assist in separating the armature 4026 and the fixed iron core 4023, thereby achieving the separation between the movable contact and the stationary contact and achieving reset.

In such an arrangement, when the coil 4022 is energized, an electromagnetic flux is generated in the fixed iron core 4023 and the yoke 4025, and the magnetic loop formed by the flux tends to close. Then, the armature 4026 is attracted to move in the direction close to the iron core, so as to drive the push rod 401 to move in order to achieve the closure of the movable contact and the stationary contact in the relay.

Referring to FIG. 6, when the movable contact on the movable spring sheet 3 is closed with the stationary contact, there is also a distance between the armature 4026 and the fixed iron core 4023, in which the distance is an overtravel movement distance H of the push rod assembly 4. That is, the armature 4026 moves from the beginning of the closure between the movable contact and the stationary contact until it is closed with the fixed iron core 4023, and this process is the overtravel movement process of the push rod assembly 4.

When the armature 4026 continues to approach the fixed iron core 4023, the push rod 401 moves with respect to the movable spring sheet 3, and the first magnetically guiding sheet 6 is slidably provided on the push rod 401, so that the first magnetically guiding sheet 6 may slide in a direction close to the second magnetically guiding sheet 8 under the self-weight of itself and/or the attraction of the second magnetically guiding sheet 8, until the restricting structure 7 restricts a position of the first magnetically guiding sheet 6, i.e., as shown in FIG. 7, until the step segment 4013 is abutted against the first magnetically guiding sheet 6.

Finally, after the armature 4026 contacts the fixed iron core 4023, the push rod assembly 4 stops actuating, the first magnetically guiding sheet 6 and the second magnetically guiding sheet 8 are in contact or spaced apart, and they generate the magnetic attraction force attracting each other via the current flowing through the movable spring sheet 3, combing the elastic force of the overtravel elastic member 5, which collectively provides the conditions for the stable closure between the movable contact of the movable spring sheet 3 and the stationary contact, which achieves a relatively good resistance effect to the electric repulsion generated by the high current under the short-circuit condition and meets the actual application needs.

### Embodiment 2

Disclosed in the present disclosure is also another short-circuit-resistant relay. The present embodiment differs from embodiment 1 only in that:

Referring to FIG. 8, in the present embodiment, the relay further includes a first sliding column 13, an end of the first sliding column 13 is fixed to the first magnetically guiding sheet 6, the first sliding column 13 slides through the blocking member 11, and the restricting structure 7 is positioned on an end of the first sliding column 13 distal to the first magnetically guiding sheet 6 and is capable of being abutted against a surface of the blocking member 11 distal to the first magnetically guiding sheet 6.

Therefore, the first magnetically guiding sheet 6 slides with respect to the blocking member 11 via the first sliding column 13, and the restricting structure 7 may be abutted against a surface of the blocking member 11 distal to the first magnetically guiding sheet 6, so as to restricts a position of the first magnetically guiding sheet 6.

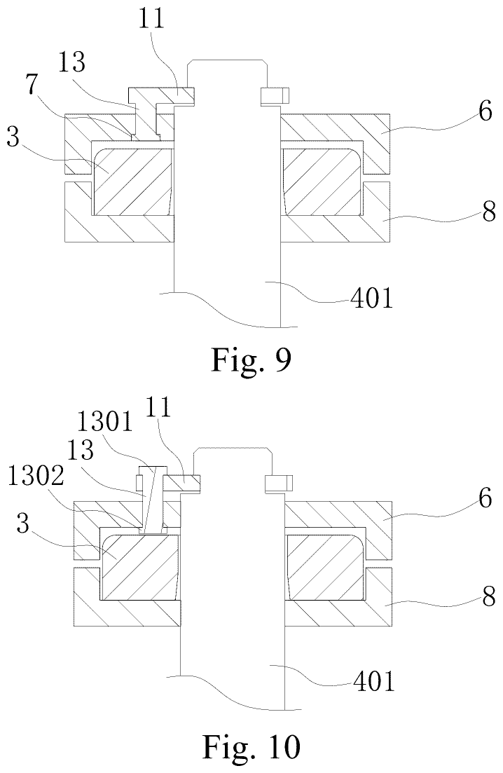

Referring to FIG. 9, in another possible implementation, an end of the first sliding column 13 is fixed to the blocking member 11, the first sliding column 13 passes through the first magnetically guiding sheet 6, and the restricting structure 7 is positioned on an end of the first sliding column 13 distal to the first magnetically guiding sheet 6 and is capable of being abutted against a surface of the first magnetically guiding sheet 6 distal to the blocking member 11.

Therefore, the first magnetically guiding sheet 6 may slide with respect to the first sliding column 13 to be abutted against the abutted against a surface of the first magnetically guiding sheet 6 distal to the blocking member 11, so that the position of the first magnetically guiding sheet 6 is restricted.

Referring to FIG. 10, in a further possible implementation, the restricting structure 7 includes a first restricting end 1301 and a second restricting end 1302, the first restricting end 1301 and the second restricting end 1302 are provided on both ends of the first sliding column 13 respectively, the first sliding column 13 slides through the first magnetically guiding sheet 6 and the blocking member 11, the first restricting end 1301 is capable of being abutted against a surface of the blocking member 11 distal to the first magnetically guiding sheet 6, and the second restricting end 1302 is capable of being abutted against a surface of the blocking member 11 distal to the first magnetically guiding sheet 6.

Therefore, both the first magnetically guiding sheet 6 and the first sliding column 13 may slide with respect to the blocking member 11, the first restricting end 1301 may be abutted against a surface of the blocking member 11 distal to the first magnetically guiding sheet 6, and the second restricting end 1302 may be abutted against a surface of the first magnetically guiding sheet 6 distal to the blocking member 11, so that the position of the first magnetically guiding sheet 6 is restricted.

### Embodiment 3

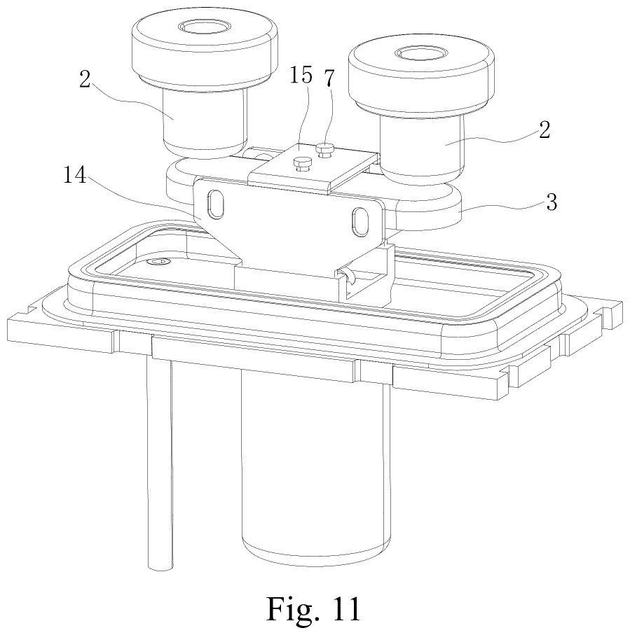

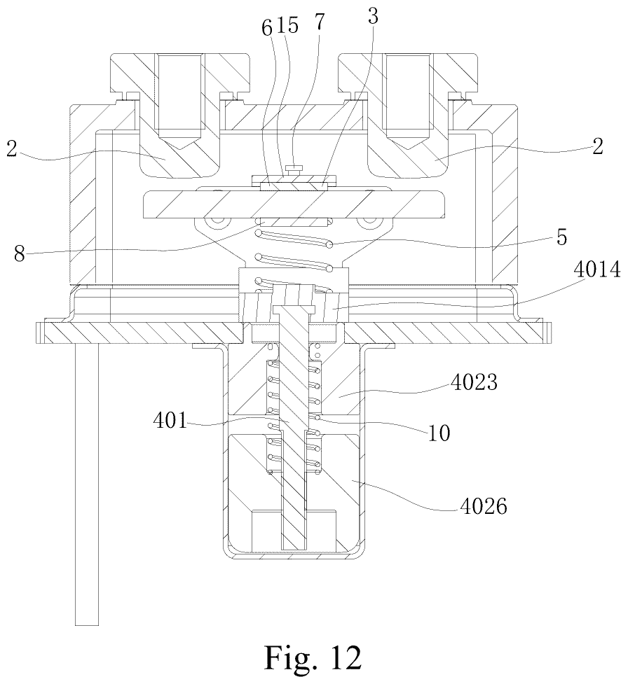

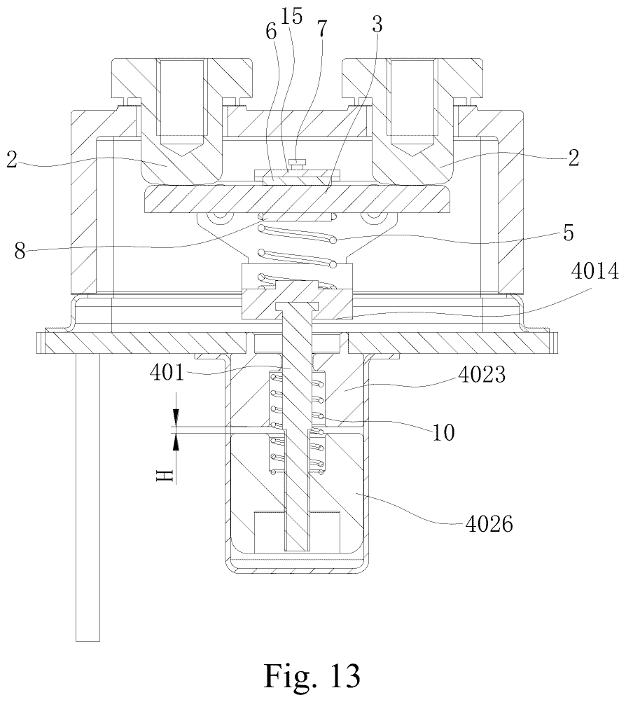

Referring to FIGS. 11-17, disclosed in the present embodiment is also another short-circuit-resistant relay. The present embodiment differs from the embodiment 1 only in that:

In the present embodiment, the push rod assembly 4 includes a push rod 401 and an electromagnetic assembly 402 driving the push rod 401 to move, an end of the push rod 401 is provided with push plate 4014, and the push plate 4014 is connected to the movable spring sheet 3 via the overtravel elastic member 5.

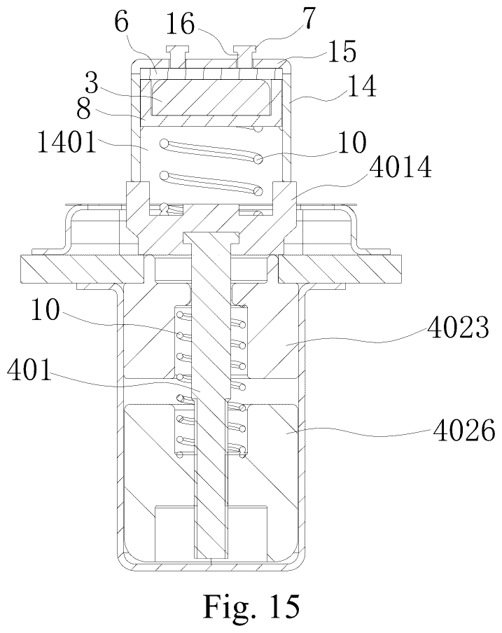

Referring to FIG. 11 and FIG. 15, in some possible implementations, two guiding plates 14 are provided on opposite sides of the movable spring sheet 3, and two guiding plates 14 form a second guiding slot 1401 for the movable spring sheet 3 to slide.

By providing a guiding plate 14, a second guiding slot 1401 is formed for the movable spring sheet 3 to slide, so as to reduce the occurrence of horizontal rotation or overturning of the movable spring sheet 3, allowing the process of the movable spring sheet 3 sliding to close the contacts to be stable and reliable.

In some possible implementations, the guiding plate 14 is provided on the fixed base 1.

Referring to FIG. 11, in some possible implementations, the guiding plate 14 is fixed to the push rod 401 and/or the push plate 4014. For example, the guiding plate 14 may be fixed to the push plate 4014. In other possible implementations, the guiding plate 14 may be fixed to the push rod 401, or fixed to both the push rod 401 and the push plate 4014.

An end of the guiding plate 14 distal to the push plate 4014 is provided with a restricting plate 15, and the first magnetically guiding sheet 6 is slidably connected to the restricting plate 15 and/or the guiding plate 14.

Therefore, by providing the restricting plate 15 may prevent the movable spring sheet 3 from detaching from an end of the guiding plate 14 away from the push plate 4014. The first magnetically guiding sheet 6 is slidably connected to the restricting plate 15 and/or the guiding plate 14, both of which are capable of achieving that the first magnetically guiding sheet 6 may slide in a direction facing the second magnetically guiding sheet 8 during the overtravel action of the push rod assembly 4.

In the present embodiment, the first magnetically guiding sheet 6 is slidably connected to the restricting plate 15.

Referring to FIGS. 11-15, in some possible implementations, the short-circuit-resistant relay further includes a second sliding column 16; an end of the second sliding column 16 is fixed to the first magnetically guiding sheet 6, the second sliding column 16 slides through the restricting plate 15, the restricting structure 7 is positioned on an end of the second sliding column 16 distal to the first magnetically guiding sheet 6.

Therefore, the first magnetically guiding sheet 6 slides with respect to the restricting plate 15 via the second sliding column 16, and the restricting structure 7 may be abutted against a surface of the restricting plate 15 distal to the first magnetically guiding sheet 6, so as to restricts a position of the first magnetically guiding sheet 6.

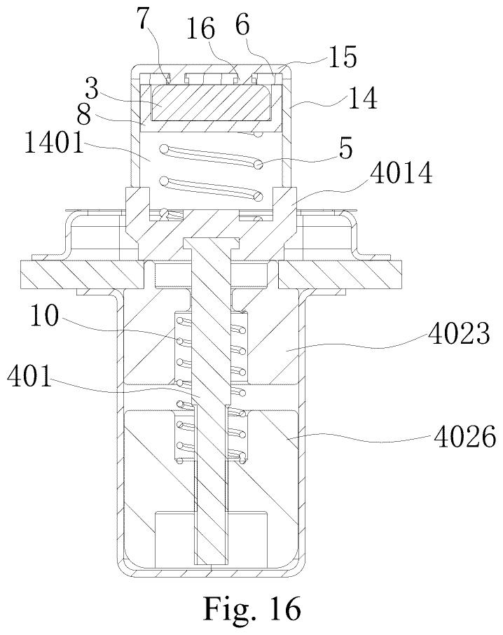

Referring to FIG. 16, in a second possible implementation, an end of the second sliding column 16 is fixed to the restricting plate 15, the second sliding column 16 passes through the first magnetically guiding sheet 6, and the restricting structure 7 is positioned on an end of the second sliding column 16 distal to the first magnetically guiding sheet 6 and is capable of being abutted against a surface of the first magnetically guiding sheet 6 distal to the restricting plate 15.

Therefore, the first magnetically guiding sheet 6 may slide with respect to the second sliding column 16 to be abutted against the abutted against a surface of the first magnetically guiding sheet 6 distal to the restricting plate 15, so that the position of the first magnetically guiding sheet 6 is restricted.

Referring to FIG. 17, in a third possible implementation, the restricting structure 7 includes a third restricting end 1601 and a fourth restricting end 1602, the third restricting end 1601 and the fourth restricting end 1602 are provided on both ends of the second sliding column 16 respectively, the second sliding column 16 slides through the first magnetically guiding sheet 6 and the restricting plate 15, the third restricting end 1601 is capable of being abutted against a surface of the restricting plate 15 distal to the first magnetically guiding sheet 6, and the fourth restricting end 1602 is capable of being abutted against a surface of the restricting plate 15 distal to the first magnetically guiding sheet 6.

Therefore, both the first magnetically guiding sheet 6 and the second sliding column 16 may slide with respect to the restricting plate 15, the third restricting end 1601 may be abutted against a surface of the restricting plate 15 distal to the first magnetically guiding sheet 6, and the fourth restricting end 1602 may be abutted against a surface of the first magnetically guiding sheet 6 distal to the restricting plate 15, so that the position of the first magnetically guiding sheet 6 is restricted.

The implementation process of the present embodiment is similar to that of the aforementioned Embodiment 1:

In such an arrangement, referring to FIGS. 2-14, during the closure of the contacts, the push rod assembly 4 drives the movable spring sheet 3 to move close to the stationary contact and allow the movable contact and the stationary contact to be in contact.

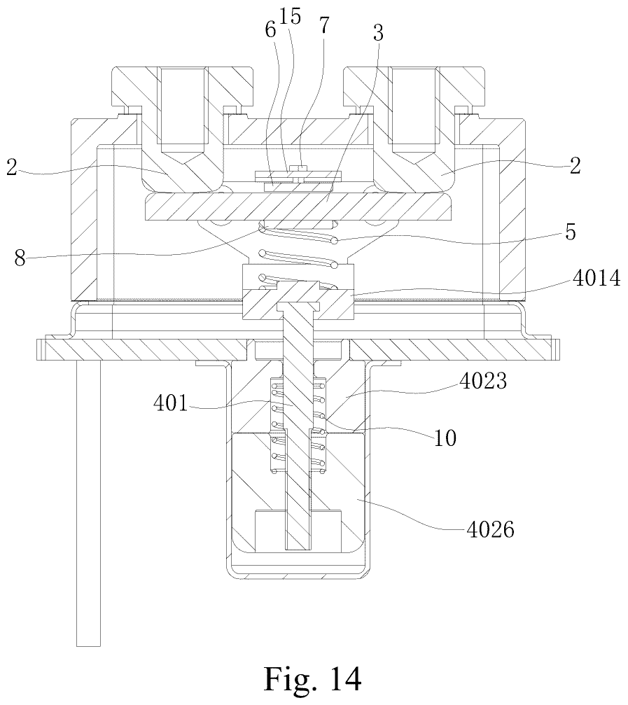

When the armature 4026 continues to approach the fixed iron core 4023, the push rod 401 moves with respect to the movable spring sheet 3 and pushes the push plate 4014 in a direction facing the stationary contact, driving the guiding plate 14 and the restricting plate 15 to move forward and compress the overtravel elastic member 5, and the first magnetically guiding sheet 6 slides with respect to the restricting plate 15, so that the first magnetically guiding sheet 6 may slide in a direction close to the second magnetically guiding sheet 8 under the self-weight of itself and/or the attraction of the second magnetically guiding sheet 8, until the restricting structure 7 restricts a position of the first magnetically guiding sheet 6, which is as shown in FIG. 14.

Finally, after the armature 4026 contacts the fixed iron core 4023, the push rod assembly 4 stops actuating, the first magnetically guiding sheet 6 and the second magnetically guiding sheet 8 are in contact or spaced apart, and they generate the magnetic attraction force attracting each other via the current flowing through the movable spring sheet 3, combing the elastic force of the overtravel elastic member 5, which collectively provides the conditions for the stable closure between the movable contact of the movable spring sheet 3 and the stationary contact, which achieves a relatively good resistance effect to the electric repulsion generated by the high current under the short-circuit condition and meets the actual application needs.

### Embodiment 4

Disclosed in the present disclosure is also another short-circuit-resistant relay. The present embodiment differs from the above embodiments only in that:

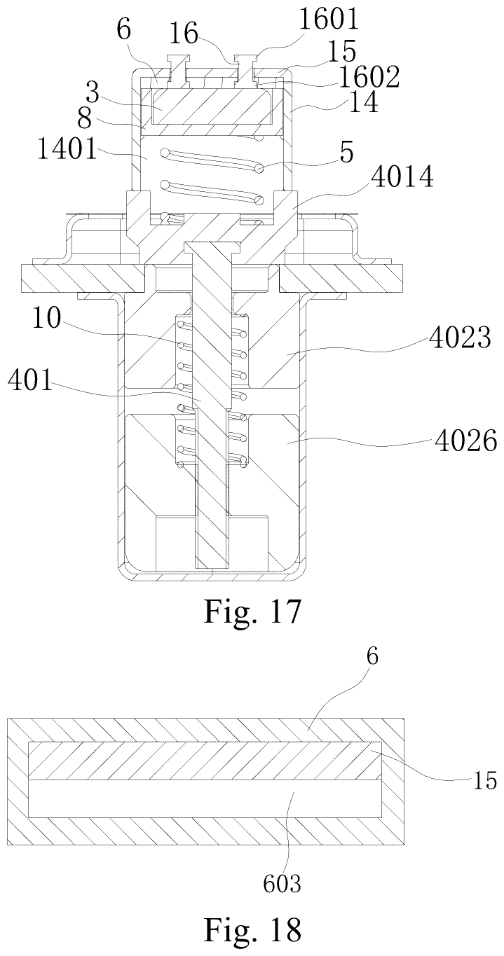

Referring to FIG. 18, the restricting structure 7 includes a restricting slot 603 provided on the first magnetically guiding sheet 6, and the restricting plate 15 is slidably connected to the restricting slot 603.

In a possible implementation, the first magnetically guiding sheet 6 is a closed structure.

The restricting plate 15 is abutted against an internal wall of the restricting slot 603 distal to the second magnetically guiding sheet 8 to restrict the travel of the first magnetically guiding sheet 6 approaching the second magnetically guiding sheet 8.

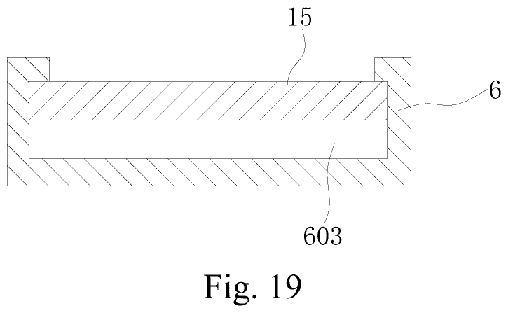

Referring to FIG. 19, in another possible implementation, the first magnetically guiding sheet 6 may be a semi-closed structure.

In summary, the short-circuit-resistant relay provided by the present disclosure enables the closure of the movable contact and the stationary contact to be more stable and reliable by shortening the distance between the first magnetically guiding sheet 6 and second magnetically guiding sheet 8 and is capable of resisting the electric repulsion generated by a larger current in the case of a short-circuit.

The technical means disclosed in the solution of the present disclosure are not limited to those disclosed in the embodiments mentioned above but also include technical solutions consisting of any combination of the above technical features. It should be noted that for those skilled in the art, a plurality of improvements and modifications may be made without departing from the principles of the present disclosure. These improvements and modifications are also considered to be within the scope of protection of the present disclosure.

1. A short-circuit-resistant relay, comprising:
a fixed base;
a contact lead-out end, fixed to the fixed base, provided with a stationary contact, provided being at least two contact lead-out ends;
a push rod assembly;
a movable spring sheet, provided with a movable contact corresponding to the stationary contact, the movable spring sheet being movably provided, in a direction parallel to a sliding direction of the push rod assembly, with respect to the push rod assembly;
a first magnetically guiding sheet, movably provided on a side of the movable spring sheet facing the stationary contact; and
a second magnetically guiding sheet, provided on a side of the movable spring sheet away from the stationary contact, capable of forming a magnetic loop with the first magnetically guiding sheet,
wherein the first magnetically guiding sheet moves in a direction facing the second magnetically guiding sheet and in parallel to a movement of the movable spring sheet within a preset travel, when the push rod assembly drives the movable spring sheet to actuate the movable contact of the movable spring sheet to contact the stationary contact of the contact lead-out end and the push rod assembly continues to actuate to achieve overtravel.

2. The short-circuit-resistant relay according to claim 1, further comprising an overtravel elastic member, applying to the movable spring sheet with an overtravel elastic force facing the stationary contact when the push rod assembly achieves an overtravel.

3. The short-circuit-resistant relay according to claim 1, further comprising a restricting structure, connected to the first magnetically guiding sheet; and the restricting structure restricts a position of the first magnetically guiding sheet when the first magnetically guiding sheet approaches the second magnetically guiding sheet in a preset travel, so that a distance between the first magnetically guiding sheet and the second magnetically guiding sheet is in a preset range.

4. The short-circuit-resistant relay according to claim 3, wherein the push rod assembly comprises a push rod and an electromagnetic assembly driving the push rod to move, the movable spring sheet is provided with a first through-hole, the push rod slidably passes through the first through-hole, and the first magnetically guiding sheet slidably connected to the push rod.

5. The short-circuit-resistant relay according to claim 4, wherein the restricting structure is provided on the push rod and positioned between the first magnetically guiding sheet and the movable spring sheet.

6. The short-circuit-resistant relay according to claim 5, wherein the restricting structure is a stopper fixedly connected to the push rod.

7. The short-circuit-resistant relay according to claim 5, wherein the push rod comprises a first sliding segment and a second sliding segment, an outer diameter of the first sliding segment is less than an outer diameter of the second sliding segment, the restricting structure is a step segment formed at a connecting position between the first sliding segment and the second sliding segment,
the first sliding segment is slidably cooperated with the first through-hole,
the first magnetically guiding sheet is provided with a second through-hole, and the first sliding segment is slidably cooperated with the second through-hole.

8. The short-circuit-resistant relay according to claim 7, wherein the first magnetically guiding sheet is provided with a fit groove cooperated with the step segment around the second through-hole, and the fit groove is positioned on a side of the first magnetically guiding sheet facing the movable spring sheet.

9. The short-circuit-resistant relay according to claim 4, wherein an end of the push rod proximal to the movable spring sheet is provided with a blocking member;
the relay further comprises a first sliding column, an end of the first sliding column is fixed to the first magnetically guiding sheet, the first sliding column slides through the blocking member, and the restricting structure is positioned on an end of the first sliding column distal to the first magnetically guiding sheet and is capable of being abutted against a surface of the blocking member distal to the first magnetically guiding sheet;
or an end of the first sliding column is fixed to the blocking member, the first sliding column passes through the first magnetically guiding sheet, and the restricting structure is positioned on an end of the first sliding column distal to the first magnetically guiding sheet and is capable of being abutted against a surface of the first magnetically guiding sheet distal to the blocking member;
or the restricting structure comprises a first restricting end and a second restricting end, the first restricting end and the second restricting end are provided on both ends of the first sliding column respectively, the first sliding column slides through the first magnetically guiding sheet and the blocking member, the first restricting end is capable of being abutted against a surface of the blocking member distal to the first magnetically guiding sheet, and the second restricting end is capable of being abutted against a surface of the blocking member distal to the first magnetically guiding sheet.

10. The short-circuit-resistant relay according to claim 3, wherein the push rod assembly comprises a push rod and an electromagnetic assembly driving the push rod to move, an end of the push rod is provided with push plate, and the push plate is connected to the movable spring sheet via an overtravel elastic member.

11. The short-circuit-resistant relay according to claim 10, further comprising two guiding plates provided on opposite sides of the movable spring sheet, two guiding plates form a second guiding slot for the movable spring sheet to slide, and
an end of the guiding plate distal to the push plate is provided with a restricting plate.

12. The short-circuit-resistant relay according to claim 11, wherein the guiding plate is provided on the fixed base.

13. The short-circuit-resistant relay according to claim 11, wherein the guiding plate is fixed to the push rod and/or the push plate, and the first magnetically guiding sheet is slidably connected to the restricting plate and/or the guiding plate.

14. The short-circuit-resistant relay according to claim 13, further comprising a second sliding column; an end of the second sliding column is fixed to the first magnetically guiding sheet, the second sliding column slides through the restricting plate, the restricting structure is positioned on an end of the second sliding column distal to the first magnetically guiding sheet and is capable of being abutted against a surface of the restricting plate distal to the first magnetically guiding sheet;
or an end of the second sliding column is fixed to the restricting plate, the second sliding column passes through the first magnetically guiding sheet, and the restricting structure is positioned on an end of the second sliding column distal to the first magnetically guiding sheet and is capable of being abutted against a surface of the first magnetically guiding sheet distal to the restricting plate;
or the restricting structure comprises a third restricting end and a fourth restricting end, the third restricting end and the fourth restricting end are provided on both ends of the second sliding column respectively, the second sliding column slides through the first magnetically guiding sheet and the restricting plate, the third restricting end is capable of being abutted against a surface of the restricting plate distal to the first magnetically guiding sheet, and the fourth restricting end is capable of being abutted against a surface of the restricting plate distal to the first magnetically guiding sheet.

15. The short-circuit-resistant relay according to claim 13, wherein the restricting structure comprises a restricting slot provided on the first magnetically guiding sheet, and the restricting plate is slidably connected to the restricting slot.
